(19) United States
(12) Patent Application Publication
(10) Pub. No.: US 2024/0326518 A1
(43) Pub. Date: Oct. 3, 2024

(54) Method for monitoring the wear of a motor vehicle tire and tire pressure monitoring module for implementing said method

(71) Applicant: Continental Automotive Technologies GmbH, Hannover (DE)

(72) Inventors: Nicolas GUINART, Toulouse (FR); Jean-Philippe BOISSET, Toulouse (FR)

(21) Appl. No.: 18/615,079

(22) Filed: Mar. 25, 2024

(30) Foreign Application Priority Data
Mar. 28, 2023 (FR) 2302953

(51) Int. Cl. B60C 11/24; G01M 17/02

(52) U.S. Cl. CPC B60C 11/243; B60C 11/246; G01M 17/02

(57) ABSTRACT

The invention relates to a method for monitoring the wear of a motor vehicle tire. According to the invention, the method comprises the following steps of:
acquiring (step E1) acceleration gradient measurements of the tire to be monitored,
performing (step E2) processing of said gradient measurements acquired,
comparing (step E3) said processed measurements to a predetermined threshold value,
transmitting a warning (step E4) when the predetermined threshold value is reached.

The invention also relates to a tire pressure monitoring module, comprising hardware and/or software means for implementing said method, said hardware and/or software means being implemented in an integrated circuit.

### CROSS REFERENCE TO RELATED APPLICATIONS

This application claims priority to French Patent Application No. 2302953, filed Mar. 28, 2023, the contents of such application being incorporated by reference herein.

### FIELD OF THE INVENTION

The present invention relates to a method for monitoring the wear of a motor vehicle tire and a tire pressure monitoring module for implementing said method.

### BACKGROUND OF THE INVENTION

Conventionally, a tire comprises on its outer surface a zone referred to as the “tread”, corresponding to the outer surface of the tire that is in contact with the roadway.

The tread comprises a relief, also called the “tread pattern”, making it possible in particular to discharge rainwater, snow, dust, heat, etc., in order to limit loss of grip of the tire or prevent aquaplaning.

Over the course of the kilometers traveled by the vehicle, the tread of the tire wears and becomes smooth, which increases the risk of loss of grip. Beyond a certain wear, it is thus necessary to replace the worn tire with a new tire.

In order to detect the wear of a tire, it is known practice to use methods for monitoring the state of wear of the tire.

A first type of method, referred to as “direct methods”, makes it possible to deduce the deterioration of the tire through the use of a device that wears at the same time as the tire.

These methods can be manual, by means of a colored wear strip incorporated into the tread. This solution is however not very satisfactory in that the owner of the vehicle must visually inspect their tire in order to determine whether it should be replaced. They must also remember to inspect their tires themselves. A person with average attention does not systematically inspect their tires and after a certain amount of time, there is a risk that they will travel in a vehicle fitted with worn tires with only little grip, which poses an obvious hazard.

There is also a growing need for autonomous monitoring of the wear of a tire, in particular in the context of vehicle fleet management, which model forms part of the growing development of new modes of mobility in which the driver is not the owner and in which tracking and maintenance are carried out by specific organizations on large groups of vehicles. Autonomous monitoring of the wear of a tire also applies to an even greater extent to autonomous vehicles.

The autonomous methods for monitoring tire wear also include direct methods that make it possible to deduce the deterioration of the tire and are implemented in particular by measuring variations in impedance of tubes that pass through the tire.

A second type of method, referred to as “indirect methods”, makes it possible to deduce a state of wear of the tire by using data originating from one or more parameters of the wheel or of the motor vehicle.

The indirect methods for automatic monitoring of tire wear include a method known as tread depth monitoring, or TDM.

This method mainly uses signals originating from systems on board the motor vehicle to deduce a state of wear of the tires therefrom.

These onboard systems comprise in particular:
a global positioning system, or GPS, which makes it possible to acquire the speed of the motor vehicle,
a wheel speed sensor, or WSS, which makes it possible to acquire the rotation speed of the wheels of the motor vehicle,
a tire pressure monitoring system, or TPMS module which makes it possible to acquire the tire pressure.

The indirect methods for automatic monitoring of tire wear also include a method known as tread depth sensing, or TDS, which aims to more directly use a signal that is perceived by the TPMS module and in which the state of wear of the tires is almost exclusively taken from this signal.

Unlike the aforementioned TDM method, in which a set of information acquired by different sensors of the motor vehicle is compiled, the TDS method is applied as close as possible to the source of the parameter to be monitored, which makes it possible to reduce the cause and effect chain used to deduce a state of wear of the tires of the motor vehicle therefrom.

Therefore, with the TDS method, the cause and effect chain is much shorter and thus more precise than the chain obtained using the TDM method.

A TDS method known from the prior art consists in using the acceleration signal in the contact zone between the tire and the ground, to deduce a state of wear of the tire therefrom.

This signal, also referred to as the “acceleration gradient in the contact zone” corresponds to the acceleration signal perceived by the TPMS module that is mounted in the tire and attached on the tread of the tire.

The accelerometer of the TPMS module monitors the acceleration gradient on rotation of the wheel on which the tire to be monitored is mounted.

Currently, the data acquired by the TPMS module is transmitted by radiofrequency to a central processing unit comprising an electronic control unit, or ECU.

Using the data acquired, the electronic control unit will develop a transfer function in order to correlate the gradient value acquired to a thickness of the tire.

Communication between the TPMS module and the processor of the central unit is relatively difficult to achieve.

This is because communication between the TPMS module that acquires the data and the processor of the central unit that processes the data requires a phase of pairing of the TPMS module and the processor of the central unit.

A strategy for communication between the TPMS module and the processor of the central unit must therefore be specifically developed to allow this communication.

In addition, it would not be obvious to implement a solution for migrating the architecture allowing direct processing in the TPMS module since some data is only accessible to the central processor and not to the TPMS module.

### SUMMARY OF THE INVENTION

An aspect of the present invention aims to overcome the drawbacks of the prior art, and to this end relates to a method for monitoring the wear of a motor vehicle tire, implemented by a tire pressure monitoring module mounted in said tire to be monitored, said module comprising a pressure sensor and a radial accelerometer, said method being notable in that it comprises the following steps of:
acquiring (step E1) acceleration gradient measurements of the tire to be monitored,
performing (step E2) processing of said gradient measurements acquired,
comparing (step E3) said processed measurements to a predetermined threshold value,
transmitting a warning (step E4) when the predetermined threshold value is reached.

An aspect of the present invention provides a solution for monitoring the wear of the tire carried out solely by the tire pressure monitoring module mounted in the tire to be monitored, which makes it possible to make said solution autonomous and easily operational.

No particular system integration is then necessary. Implementing the method according to an aspect of the invention by means of a tire pressure monitoring module mounted in the tire to be monitored avoids having to transmit information to the central processor of the central processing unit of the motor vehicle, which in particular has a direct influence on the power consumption and service life of the monitoring module.

The information can also be used more directly compared to the prior art, and therefore more efficiently. The tire pressure monitoring module thus gives more refined information, which makes it possible to increase the relevance of the development of a wear processing strategy.

The monitoring method according to an aspect of the invention makes it possible to monitor and process the dynamics of the acceleration gradient, making it possible to deduce a significant level of wear therefrom, which will make it possible to transmit a warning if applicable.

Thus, unlike in the solutions known from the prior art, use is not made of a transfer function converting an acceleration gradient unit into a consumed thickness of the tread of the tire.

According to optional features of the method according to an aspect of the invention:
in a first embodiment, the acquisition step (step E1) comprises a sub-step (step E11) of learning initial conditions aiming to determine an initial reference acceleration gradient (Grad₀);
the initial reference acceleration gradient (Grad₀) is equal to the mean of the acceleration gradients measured over a predetermined number of kilometers traveled by the monitored tire;
the acquisition step (step E1) comprises a sub-step (step E12) subsequent to said sub-step (step E11) of learning initial conditions and comprising the acquisition of measurements of instantaneous gradients Grad(t) or the acquisition of a mean gradient Gradₘₑₐₙ equal to the mean of acceleration gradients measured over a predetermined number of kilometers traveled by the monitored tire;
the step of processing (step E2) the gradient measurements acquired during the acquisition step (step E1) is carried out by applying an identity function on the basis of which a gradient value is calculated, equal to the difference, as an absolute value, between the instantaneous gradient Grad(t) and the reference gradient Grad₀, or the difference, as an absolute value, between the mean gradient Gradₘₑₐₙ and the reference gradient Grad₀;
the comparison step (step E3) is performed by comparing the gradient value obtained at the end of the processing step (step E2) to a predetermined threshold value (Grad_{threshold 1});
if said gradient value obtained at the end of the processing step (step E2) is greater than said predetermined threshold value (Grad_{threshold 1}), then the warning transmission step (step E4) is triggered;
in one embodiment, the monitoring method comprises a step aiming to predict (step E5) the distance remaining before a predetermined level of wear of the monitored tire is reached;
said step aiming to predict (step E5) the distance remaining before a predetermined level of wear of the monitored tire is reached is implemented following the warning transmission step (step E4);
alternatively, said step aiming to predict (step E5) the distance remaining before a predetermined level of wear of the monitored tire is reached is implemented before the warning transmission step is reached;
in a second embodiment of the monitoring method according to an aspect of the invention, the acceleration gradient measurement acquisition step (step E1) is carried out by periodically measuring the instantaneous acceleration gradient Grad (t) for an iteration i and for an iteration i−k, k>0, each of said iterations being carried out over a predetermined distance window;
the processing step (step E2) deduces, on the basis of the values acquired during the acquisition step (step E1), a mean gradient value Gradₘₑₐₙ_{ᵢ}, representing the mean of the instantaneous acceleration gradients Grad (t) for an iteration i, and a mean gradient value Gradₘₑₐₙ_{ᵢ₋ₖ}, k>0, representing the mean of the instantaneous acceleration gradients Grad (t) for an iteration i−k;
the processing step (step E2) is carried out by applying a derivative function on the basis of which a derivative gradient value is calculated, equal to the difference, as an absolute value, between the derivative relative to time of the mean gradient value Gradₘₑₐₙ_{ᵢ} on iteration i and the derivative relative to time of the mean gradient value Gradₘₑₐₙ_{ᵢ₋ₖ} on iteration i−k, k>0;
the comparison step (step E3) is performed by comparing said derivative gradient value obtained at the end of the processing step (step E2) to a predetermined threshold value (Grad_{threshold 2});
if said derivative gradient value obtained at the end of the processing step (step E2) is greater than said predetermined threshold value (Grad_{threshold 2}), then the warning transmission step (step E4) is triggered;
said acquisition step (step E1) of acquiring the acceleration gradient measurements of the tire to be monitored is initiated after a predetermined number of kilometers has been traveled by said tire to be monitored;
the acceleration gradient value of the tire to be monitored is a compensated value;
the acceleration gradient measurements acquired during the acquisition step (step E1) are the entry acceleration gradient (Grad_{entry}), and/or the exit acceleration gradient (Grad_{entry})), and/or the relative difference between the entry acceleration gradient (Grad_{entry}) and the exit gradient (Gradₑₓᵢₜ).

An aspect of the invention also relates to a tire pressure monitoring module, comprising hardware and/or software means for implementing the method according to an aspect of the invention, notable in that said hardware and/or software means are implemented in an integrated circuit.

### BRIEF DESCRIPTION OF THE DRAWINGS

Other features, aims and advantages of aspects of the invention will become apparent upon reading the following detailed description, in order to understand which reference will be made to the appended drawings, in which:

FIG. 1 is a schematic view of a tire of a motor vehicle wheel according to an aspect of the invention.

FIG. 2 shows a curve representing the radial acceleration value Z of a module for monitoring the pressure of a tire to be monitored as a function of time t.

FIG. 3 shows a comparison of acceleration gradient signals from a first tire and a second tire.

FIG. 4 sets out the steps of the method for monitoring the wear of a motor vehicle tire according to an aspect of the invention.

FIG. 5 sets out the steps of the monitoring method according to a first embodiment of the invention.

FIG. 6 shows an exemplary embodiment of the step of predicting the distance remaining before the tire becomes completely worn.

FIG. 7 shows an example of a curve tracking the derivative relative to time of mean acceleration gradient values.

### DETAILED DESCRIPTION OF THE PREFERRED EMBODIMENTS

In the description hereinafter, elements with an identical structure or similar functions are denoted by the same reference sign.

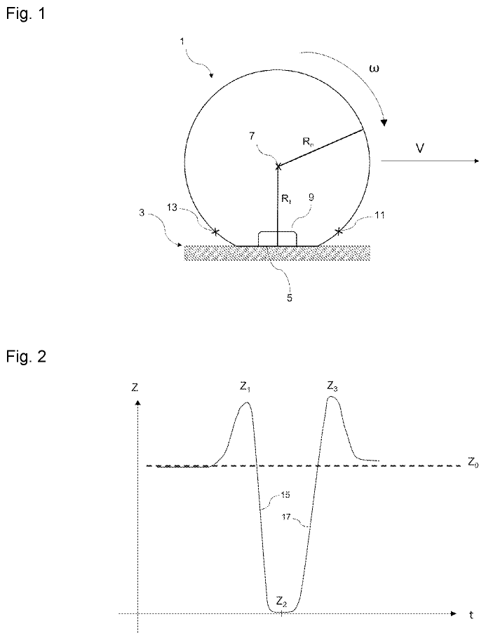

Reference is made to FIG. 1, which shows a tire 1 of a motor vehicle wheel according to an aspect of the invention.

The tire 1, mounted on a motor vehicle wheel (not shown) rests on the ground 3.

The tire 1 comprises a nominal radius Rₙ defined by the radius of the tire 1 when the wheel is unladen, that is, not mounted on the vehicle.

The laden tire 1 is deformed in the contact zone 5 between the tire 1 and the ground 3, on its tread.

In this contact zone, the radius of the tire 1 is defined by the laden radius R_{c}, which corresponds to the distance between the axis of rotation 7 of the wheel and the ground 3.

The tire 1 comprises a tire pressure monitoring system, or TPMS, module 9 according to an aspect of the invention, which makes it possible to acquire the tire pressure.

The TPMS module 9 according to an aspect of the invention comprises hardware and software means capable of implementing the method of an aspect of the invention. The software means comprise computer program code means, comprising in particular the algorithm implemented to execute the method of an aspect of the invention, while the hardware means comprise an electronic module comprising a tire pressure sensor and a radial accelerometer capable of monitoring the acceleration of the wheel.

In one embodiment of the invention, the hardware and/or software means for implementing the method according to an aspect of the invention may be implemented in an integrated circuit.

In the position of the wheel illustrated in FIG. 1, the TPMS module 9 is in contact with the ground 3.

FIG. 2 depicts the curve showing an example of a radial acceleration value Z perceived by the TPMS module 9 as a function of time t, for one complete rotation of the wheel on which the tire 1 is mounted.

The periodic signal representing the acceleration curve fluctuates around a static value Z₀ equal to the product of the nominal radius Rₙ defined by the following formula:

$${Z}_{0} = {R}_{n} \cdot {ω}^{2}$$

where:
Z₀ is a static value of the acceleration of the wheel,
Rₙ is the nominal radius of the wheel,
ω is the rotation speed of the wheel.

At the moment when the TPMS module 9 arrives almost in contact with the ground when the tire 1 is rotating in the direction of the arrow shown in FIG. 1, a pinching zone 11 of the tire 1 (visible in FIG. 1) is generated between the tire 1 and the ground 3.

This pinching zone 11 is reflected in a local reduction in the nominal radius Rₙ of the tire 1.

Since the TPMS module 9 continues to rotate at the rotation speed ω, the local reduction in the nominal radius Ry of the tire 1 in the pinching zone 11 causes an increase in the radial acceleration Z perceived by the TPMS module 9.

This increase in the radial acceleration Z perceived by the TPMS module 9 is represented in FIG. 2 by a local peak in radial acceleration Z₁ perceived by the TPMS module 9 in the pinching zone 11.

Once the TPMS module 9 has gone through the pinching zone 11 and arrived in the contact zone 5 with the ground 3, the acceleration Z₂ perceived by the TPMS module 9 is zero, as the TPMS module 9 is no longer in motion.

Likewise, when the TPMS module 9 leaves the contact zone 5 with the ground 3, a pinching zone 13 of the tire 1 (visible in FIG. 1) is generated between the tire 1 and the ground 3. This pinching zone 13 is also reflected in a local reduction in the nominal radius Rₙ of the tire 1, causing an increase in the radial acceleration Z perceived by the TPMS module 9, represented in FIG. 2 by a local peak in radial acceleration Z₃ in the pinching zone 13.

The peaks in radial acceleration Z₁ or Z₃ perceived by the TPMS module 9 are reflected in a phenomenon commonly referred to as “overshoot”.

The portion 15 of the acceleration curve between Z₁ and Z₂ defines an entry acceleration gradient Grad_{entry} with respect to the contact zone 5 with the ground 3 and the portion 17 of the acceleration curve between Z₂ and Z₃ defines an exit acceleration gradient Gradₑₓᵢₜ with respect to the contact zone 5 with the ground 3.

The acceleration gradient in the contact zone defines a signal commonly referred to as a “footprint” signal.

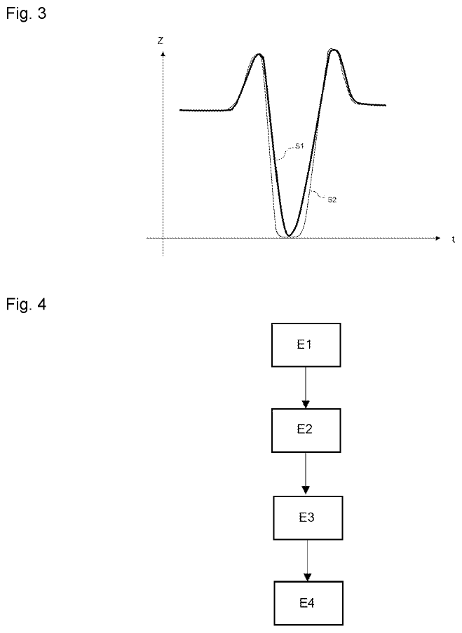

Reference is made to FIG. 3, which shows a comparison between a “footprint” signal S1 of a first tire, shown in bold, and a “footprint” signal S2 of a second tire, having greater wear than the first tire.

The entry Grad_{entry} and exit Gradₑₓᵢₜ acceleration gradients of the second tire each have a slope greater than the slopes obtained for the first, less worn tire.

As the second tire is thinner than the first tire due to its greater wear, the radius of curvature of the second tire in the pinching zones 11, 13 is smaller than that of the first tire.

Note that other parameters can however influence the acceleration gradient. These parameters are, for example, the tire pressure, the load applied to the tire, and the speed of the vehicle.

In the context of an aspect of the present invention, the acceleration gradient value used is a compensated value, in other words the value of the gradient used only reflects the wear of the tire.

The method implemented to compensate the acceleration gradient with the other parameters does not form part of an aspect of the present invention and is therefore not described in greater detail.

Reference is made to FIG. 4, which shows the steps of the method for monitoring the wear of a motor vehicle tire according to an aspect of the invention.

The monitoring method according to an aspect of the invention is implemented by the TPMS module 9 of the tire 1 and comprises the following steps of:
step E1: acquiring acceleration gradient measurements of the tire 1,
step E2: performing processing of the gradient measurements acquired during step E1,
step E3: comparing said processed measurements to a predetermined threshold value,
step E4: transmitting a warning when the predetermined threshold value is reached.

The method according to an aspect of the invention thus aims to monitor the changes in the acceleration gradient over time and transmit a warning signal when the gradient exceeds a certain threshold.

The monitoring method according to an aspect of the invention thus makes it possible to deduce a significant state of wear of the monitored tire on the basis of the monitoring of changes in its acceleration gradient.

An aspect of the present invention thus provides a solution for monitoring tire wear carried out solely by the TPMS module 9 of the tire 1.

The acceleration gradient measurements acquired in the context of an aspect of the present invention are:
the entry acceleration gradient Grad_{entry}, or
the exit acceleration gradient Gradₑₓᵢₜ, or
the relative difference between the entry acceleration gradient Grad_{entry} and the exit gradient Gradₑₓᵢₜ.

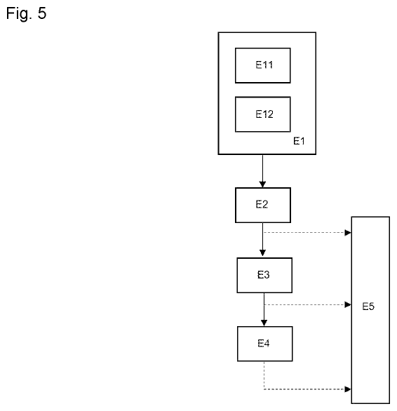

Reference is made to FIG. 5 describing a first embodiment of the monitoring method of the invention.

The acquisition step E1 comprises a first sub-step E11 of learning initial conditions.

The learning step E11 is typically initiated when the tire to be monitored is new.

The purpose of the learning step E11 is to determine a reference acceleration gradient Grad₀.

To this end, in the learning phase E11, acceleration gradient measurements of the tire 1 are acquired, which may be entry acceleration gradient Grad_{entry} measurements or exit acceleration gradient Gradₑₓᵢₜ measurements or entry Grad_{entry} and exit Gradₑₓᵢₜ acceleration gradient measurements in order to deduce therefrom a relative difference between the entry Grad_{entry} and exit Gradₑₓᵢₜ acceleration gradient.

A reference acceleration gradient Grad₀ is determined, which may be the initial reference acceleration gradient averaged over a predetermined number of kilometers in the life of the tire 1 to be monitored.

The reference gradient Grad₀ may be equal to the mean of the acceleration gradients measured for example over the first thousand kilometers in the life of the tire 1.

The learning phase thus makes it possible to indicate the value of the gradient that the monitored tire is supposed to have at the start of its life.

As a variant, the learning step E11 may be omitted and the reference gradient value Grad₀ may be determined by any other means. In particular, the reference gradient value Grad₀ may be read from charts and entered into the algorithm for implementing the method of an aspect of the invention.

The acquisition step E1 then comprises a second sub-step E12 of acquiring continuous measurements of acceleration gradients, initiated when the reference gradient Grad₀ has been set.

The sub-step, step E12, of acquiring continuous measurements comprises in a first embodiment the acquisition of instantaneous gradient Grad(t) measurements.

In a second embodiment of the sub-step, step E12, the acquisition of continuous measurements is carried out by finding the mean of consecutive gradient measurements.

For example, a series of measurements is taken over a predetermined number of kilometers, and the mean of these measurements is found in order to deduce a mean gradient Gradₘₑₐₙ. therefrom.

The consecutive measurements with a view to calculating the mean thereof may be taken over a distance range, for example equal to around 50 kilometers.

The step E2 of processing the gradient measurements acquired in step E1 is carried out using an “identity” function, which is an affine function of the changes in gradient over time.

On the basis of this identity function, in step E2 the difference is calculated, as an absolute value, between the instantaneous gradient Grad(t) and the reference gradient Grad₀, or between the mean gradient Gradₘₑₐₙ and the reference gradient Grad₀.

In step E3, the value obtained in the processing step E2 is compared to a predetermined threshold value Grad_{threshold 1}.

If |Grad(t)−Grad₀|>Grad_{threshold 1}, then a tire wear warning is generated (step E4).

The warning may be transmitted by radiofrequency, for example.

If the gradient threshold value Grad_{threshold 1} is exceeded, this means that the gradient has increased relative to the reference gradient Grad₀, and therefore that the tire is worn.

Since the acceleration gradient value used is a compensated value that only reflects the wear of the tire, the other parameters that can influence the acceleration gradient value (in particular the tire pressure, the load applied to the tire, and the speed of the vehicle) do not affect the triggering of the steps of the method of an aspect of the invention, particularly step E4 for transmitting a warning when the predetermined threshold value Grad_{threshold 1} is reached.

In this first embodiment of the method according to the invention, a step E5 of predicting the distance remaining before a predetermined level of wear of the monitored tire is reached may be initiated.

The predetermined level of wear may for example correspond to a level of complete wear of the monitored tire.

Step E5 may be implemented before the gradient threshold value Grad_{threshold 1} is reached, that is, at any time after step E2 of processing the gradient measurements acquired during step E1 is finished, and before the warning transmission step E4 is initiated. A message to the central processing unit is then regularly transmitted without the gradient threshold value Grad_{threshold 1} necessarily being reached.

As a variant, step E5 may be initiated when the gradient threshold value Grad_{threshold 1} is reached, that is, following step E4.

In one exemplary embodiment, step E5 of predicting the distance remaining before a predetermined level of wear of the monitored tire is reached may be implemented periodically.

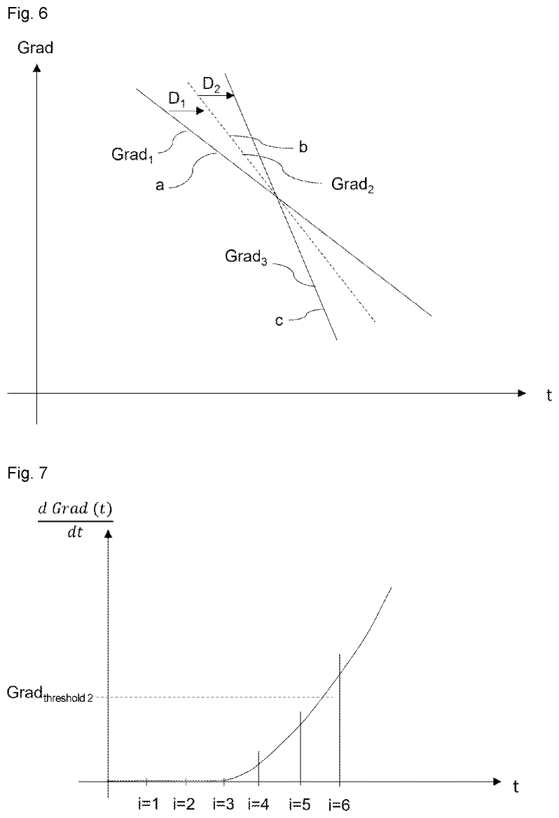

Reference is made to FIG. 6, which shows an exemplary embodiment of step E5 of predicting the distance remaining before the monitored tire becomes completely worn.

In this exemplary embodiment of step E5, we go from a gradient Grad₁ having a slope a to a gradient Grad₂ having a slope b after having traveled a distance D₁.

The assumption is that the evolution between the curve Grad₁ and the curve Grad₂ takes place linearly.

Based on this assumption, it is considered that to reach the value Grad₃ having a slope c and representing a predetermined level of wear of the monitored tire, for example complete wear, the distance D2 to be traveled is equal to the distance D1.

The distance remaining may be extrapolated using the following formula:

$$K {m}_{r e m a i n i n g} = K m ( t ) \cdot ( \frac{{Grad}_{threshold 1}}{\vert Grad ( t ) - {Grad}_{0} \vert} - 1 )$$

where:
Km_{remaining} is the value of the distance remaining before the predetermined level of wear is reached,
Km(t) is the value of the current distance traveled.

The monitoring method of an aspect of the invention may be implemented by a second embodiment.

It has been observed that, as the tire wears, the gradient stiffens substantially linearly as a function of the loss of thickness of the tire tread.

It has also been observed that, approaching a maximum gradient value corresponding to a highly advanced or terminal state of wear of the tire, the variations in gradient become much more dynamic. These variations in gradient are characterized by the derivative of the gradient relative to time.

Unlike in the first embodiment, the second embodiment does not comprise a step of learning a reference gradient Grad₀ (step E11 of the first embodiment) or entering the reference gradient Grad₀ read from charts into the algorithm for implementing the method of an aspect of the invention.

In the execution of the method according to the second embodiment of the invention, step E1 of acquiring acceleration gradient measurements may be carried out cyclically by taking a plurality of acceleration gradient measurements over a current cycle.

For example, for an iteration i performed over a predetermined distance window, the instantaneous gradient Grad(t) is measured periodically on a time basis.

The distance window may for example be equal to 100 kilometers.

The time base selected may for example be a minute, that is, a measurement is taken every minute.

As a variant, the instantaneous gradient Grad(t) may be measured periodically, over the aforementioned predetermined distance window, on a distance basis, for example every kilometer.

Given that there is a running-in phase during which certain parameters specific to the vehicle are set up, step E1 may be initiated after a predetermined number of kilometers has been traveled by the tire to be monitored.

Step E2 of processing the gradient measurements deduces a mean value of the gradient Gradₘₑₐₙ_{ᵢ} on iteration i and a mean value of the gradient Gradₘₑₐₙ_{ᵢ₋₁} on iteration i−1.

Step E2 of processing the gradient measurements then calculates the derivative in time of the mean gradient values Gradₘₑₐₙ_{ᵢ} acquired for each iteration i and i−1.

FIG. 7 shows an example of the evolution of the derivative in time of the mean gradient values for iterations i=1 to i=6.

In the exemplary embodiment shown, the value of the derivative of the gradient in time is zero over iterations i=1 to i=3.

From iteration i=4, the derivative increases until, between iteration i=5 and iteration i=6, it exceeds the predetermined threshold value Grad_{threshold 2}.

In step E3, the values Gradₘₑₐₙ_{ᵢ} obtained upon iterations i=1 to i=6 in processing step E2 are compared to the predetermined threshold value Grad threshold 2.

If

$$\vert \frac{d}{dt} {Grad}_{{mean}_{i}} - \frac{d}{dt} {Grad}_{m e a {n}_{i - 1}} \vert > {Grad}_{threshold 2} ,$$

then a tire wear warning is generated (step E4) and transmitted by radiofrequency.

According to a variant embodiment, step E2 of processing the gradient measurements deduces a mean value of the gradient Gradₘₑₐₙ_{ᵢ} on iteration i and a mean value of the gradient Gradₘₑₐₙ_{ᵢ₋ₖ} on iteration i−k, with k>1.

The tire wear warning may thus be generated (step E4) not by comparison between iterations i and i−1 but by comparison between iterations i and i−2, i−3, etc.

By virtue of this second embodiment, the significant variations in gradient are detected, which makes it possible to deduce that the tire has exceeded its maximum wear level and therefore that the tire is close to the end of its life.

Of course, aspects of the present invention are not limited solely to the embodiments of this method for monitoring the wear of a motor vehicle tire and of this tire pressure monitoring module for implementing said method, which are described above purely by way of illustrative example, and it encompasses all variants involving technical equivalents of the means described.

1. A method for monitoring the wear of a motor vehicle tire, implemented by a tire pressure monitoring module mounted in said tire to be monitored,
said module comprising a pressure sensor and a radial accelerometer,
said method comprising:
acquiring acceleration gradient measurements of the tire to be monitored,
performing processing of said gradient measurements acquired,
comparing said processed measurements to a predetermined threshold value, and
transmitting a warning when the predetermined threshold value is reached.

2. The monitoring method as claimed in claim 1, wherein the acquisition step comprises a sub-step of learning initial conditions aiming to determine an initial reference acceleration gradient (Grad₀).

3. The monitoring method as claimed in claim 2, wherein the initial reference acceleration gradient (Grad₀) is equal to the mean of the acceleration gradients measured over a predetermined number of kilometers traveled by the monitored tire.

4. The monitoring method as claimed in claim 2, wherein the acquisition step comprises a sub-step subsequent to said sub-step of learning initial conditions and comprising the acquisition of measurements of instantaneous gradients Grad(t) or the acquisition of a mean gradient Gradₘₑₐₙ equal to the mean of acceleration gradients measured over a predetermined number of kilometers traveled by the monitored tire.

5. The monitoring method as claimed in claim 4, wherein the step of processing the gradient measurements acquired during the acquisition step is carried out by applying an identity function on the basis of which a gradient value is calculated, equal to:
the difference, as an absolute value, between the instantaneous gradient Grad(t) and the reference gradient Grad₀, or
the difference, as an absolute value, between the mean gradient Gradₘₑₐₙ and the reference gradient Grad₀.

6. The monitoring method as claimed in claim 5, wherein the comparison step is performed by comparing the gradient value obtained at the end of the processing step to a predetermined threshold value (Grad_{threshold 1}).

7. The monitoring method as claimed in claim 6, wherein if said gradient value obtained at the end of the processing step is greater than said predetermined threshold value (Grad_{threshold 1}), then the warning transmission step is triggered.

8. The monitoring method as claimed in claim 5, further comprising aiming to predict the distance remaining before a predetermined level of wear of the monitored tire is reached.

9. The monitoring method as claimed in claim 8, wherein said step aiming to predict the distance remaining before a predetermined level of wear of the monitored tire is reached is implemented following the warning transmission step.

10. The monitoring method as claimed in claim 8, wherein said step aiming to predict the distance remaining before a predetermined level of wear of the monitored tire is reached is implemented before the warning transmission step is reached.

11. The monitoring method as claimed in claim 1, wherein the acceleration gradient measurement acquisition step is carried out by periodically measuring the instantaneous acceleration gradient Grad (t) for an iteration i and for an iteration i−k, k>0, each of said iterations being carried out over a predetermined distance window.

12. The monitoring method as claimed in claim 11, wherein the processing step deduces, on the basis of the values acquired during the acquisition step:
a mean gradient value Gradₘₑₐₙ_{ᵢ}, representing the mean of the instantaneous acceleration gradients Grad (t) for an iteration i, and
a mean gradient value Gradₘₑₐₙ_{ᵢ₋ₖ}, k>0, representing the mean of the instantaneous acceleration gradients Grad (t) for an iteration i−k.

13. The monitoring method as claimed in claim 12, wherein the processing step is carried out by applying a derivative function on the basis of which a derivative gradient value is calculated, equal to the difference, as an absolute value, between the derivative relative to time of the mean gradient value Gradₘₑₐₙ_{ᵢ} on iteration i and the derivative relative to time of the mean gradient value Gradₘₑₐₙ_{ᵢ₋ₖ} on iteration i−k, k>0.

14. The monitoring method as claimed in claim 13, wherein the comparison step is performed by comparing said derivative gradient value obtained at the end of the processing step to a predetermined threshold value (Grad_{threshold 2}).

15. The monitoring method as claimed in claim 14, wherein if said derivative gradient value obtained at the end of the processing step is greater than said predetermined threshold value (Grad_{threshold 2}), then the warning transmission step is triggered.

16. The monitoring method as claimed in claim 11, wherein said acquisition step of acquiring the acceleration gradient measurements of the tire to be monitored is initiated after a predetermined number of kilometers has been traveled by said tire to be monitored.

17. The monitoring method as claimed in claim 1, wherein the acceleration gradient value of the tire to be monitored is a compensated value.

18. The monitoring method as claimed in claim 1, wherein the acceleration gradient measurements acquired during the acquisition step are:
the entry acceleration gradient (Grad_{entry}), and/or
the exit acceleration gradient (Gradₑₓᵢₜ), and/or
the relative difference between the entry acceleration gradient (Grad_{entry}) and the exit gradient (Gradₑₓᵢₜ).

19. A tire pressure monitoring module, comprising hardware and/or software for implementing the method as claimed in claim 1, wherein said hardware and/or software are implemented in an integrated circuit.
